(19) United States
(12) Patent Application Publication
(10) Pub. No.: US 2008/0040221 A1
(43) Pub. Date: Feb. 14, 2008

(54) Interest Targeting

(75) Inventors: Leora Ruth Wiseman, Sunnyvale, CA (US); Shivakumar Venkataraman, Santa Clara, CA (US); Sridhar Ramaswamy, Cupertino, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 11/836,011

(22) Filed: Aug. 8, 2007

Related U.S. Application Data
(60) Provisional application No. 60/821,778, filed on Aug. 8, 2006.

(51) Int. Cl. G06Q 30/00; G06Q 40/00

(52) U.S. Cl. 705/14; 705/1; 705/37

(57) ABSTRACT

An advertisement can be presented by associating a label with an advertisement, receiving input from a user, wherein the input comprises one or more labels, identifying a match between the label associated with the advertisement and the input, and presenting the advertisement to the user. A bid further can be received for presenting the advertisement in response to input from a user that includes the associated label and an advertisement presentation order can be determined based on one or more of the bid, a click-through rate of the advertisement, and a conversion rate of the advertisement. Additionally, a negative label can be associated with the advertisement. Further, an additional input comprising one or more labels can be received from the user, a match can be identified between the negative label and the received additional input, and it can be determined not to present the advertisement based on the identified match.

This application claims the benefit of U.S. Provisional Application No. 60/821,778, filed Aug. 8, 2006. The disclosure of the prior application is considered part of (and is incorporated by reference in) the disclosure of this application.

### BACKGROUND

The present disclosure relates to advertising in an information search and retrieval system, for example, by including an advertisement in search results provided in response to a search request, and to strategies for selecting advertisements that are relevant to a corresponding search request.

A wide variety of information is made available through the collection of billions of web pages that comprise the Internet. As there is no central index or single reference catalog for the Internet that classifies the information contained on a given web page or collection of web pages, locating a desired item of information on the World Wide Web can be difficult. Additionally, because the content of a web page typically is controlled by the individual host, determining whether particular content is still available at a given location can be difficult.

Directories were developed as an early tool for indexing web pages. By providing links to (or addresses of) particular pages, a directory can make it easier to locate content relating to a specific topic. Some directories provide links to web pages that relate to a single topic, while others index web pages relating to a plurality of topics. Advertisements, such as banner ads, can be displayed on a directory page so that they can be viewed by visitors. Because the one or more topics of a directory are fixed, an advertisement associated with the directory can be selected such that it has at least some relevance to the content indexed by the directory. Advertisement selection can be controlled by a person, such as by an advertiser or the directory administrator. Nonetheless, a directory can provide access only to a limited range of predetermined content.

Search engines, such as the engine provided by Google™, were developed to dynamically generate an index of web pages relating to a user defined search request. Typically, a user submits a search request to a search engine in the form of a search string comprising one or more keywords. In response to the submitted search string, the search engine generates a list of web pages that are believed to relate to the search request. Once generated, the list can be presented to the user through a graphical user interface (GUI), such as in a series of Uniform Resource Locators (URLs), graphical icons, titles, summaries, descriptions, or any combination thereof. The requesting user is then free to browse the list and select one or more links based on the description provided. If the list does not contain information for which the user was searching, the user can refine the initial search string through the use of additional and/or different keywords. The search engine can be configured to generate a list of web pages dynamically in response to each search request it receives.

The quality of the results returned by a search engine in response to a search string submitted by a user can vary. For example, if a large number of web pages include or otherwise refer to a generic keyword or keyword combination, a search string comprising that keyword or keyword combination can produce an extensive list of results. It is possible that many of these results will not be relevant to the user. Conversely, a search string comprising one or more unique keywords that are associated with a small number of web pages can generate a short list of highly relevant results.

It often is necessary, however, to use one or more generic keywords in formulating a search string. Therefore, additional searching strategies have been developed in order to produce more relevant results. For example, a search engine can support an exact match requirement so that only results containing an exact match for one or more keywords are displayed. An additional search strategy can utilize Boolean search strings through which a user can specify one or more logical rules to filter search results. Even with these refinements, however, a search engine may not be able to accurately discern a user's intent based solely on a received search string.

In addition to returning a dynamically generated list of web pages, search engines often also display one or more advertisements in response to a search request. An advertisement is typically displayed such that it is viewable in conjunction with the search results. Similar to search results, an advertisement also can be selected for display based on the search string specified by the user. For example, it is possible that a user who enters a search string including the term “car” will be more interested in an advertisement that relates to cars than a user searching for different subject matter, such as flowers. Therefore, an advertiser can choose to have an advertisement associated with one or more keywords that are believed to indicate that a user is likely to be interested in the product or service being advertised. The advertisement can then be displayed when a corresponding search string is submitted by a user.

In one advertising model, an advertiser can purchase one or more keywords for a given period of time. The advertiser also can purchase a particular keyword combination. The advertiser can then associate the purchased keyword or keyword combination with an advertisement such that the advertisement is displayed when a search string containing the keyword or keyword combination is received from a user. Another advertising model is to permit advertisers to bid on keywords and keyword combinations for a particular event, such as a single instance or impression. A bid can be any offer of consideration, including an amount of money. Advertisers' bids for a particular keyword or keyword combination can be evaluated when a corresponding search string is received and the advertisement belonging to the winning advertiser can be displayed. Depending on the advertising model, more than one winning advertiser can be selected for an instance, and one or more factors, including the respective bids, can be used to determine placement and ordering of the advertisements.

As with search results, however, associating an advertisement with one or more keywords does not guarantee that the advertisement will be relevant to every search request containing that keyword or keyword combination. Further, associating an advertisement with a keyword does not permit an advertiser to target users who have a specific goal or intent. For example, it can be difficult for an advertiser to target an advertisement exclusively to tourists who are visiting San Francisco and are searching for a seafood restaurant. Instead, the advertiser can simply have the advertisement displayed to any user who enters a search request containing the one or more specific keywords associated with that advertisement.

Further, a single concept or topic can be described using a plurality of equivalent or interchangeable terms. This is referred to as synonymy. Thus, in order to achieve a desired amount of coverage, an advertiser seeking to display an advertisement in response to a search request relating to automotive vehicles may be required to associate that advertisement with a plurality of keywords, such as car, auto, automobile, vehicle, coupe, sedan, and convertible. Through the use of a broad range of keywords, however, the advertiser can cause the advertisement to be displayed to users for whom the product or services are irrelevant. In addition to a single concept being described by multiple terms, a single term also can be used to describe multiple concepts. This is referred to as polysemy. For example, because the term “convertible” relates to several distinct contexts, using convertible as a keyword in isolation also can result in the display of an advertisement that is irrelevant to the intended search results.

Further, even when a keyword identifies a single topic, it may nonetheless be impossible to determine the user's specific intent based solely on that keyword. For example, a user entering a search string comprising the keyword airplane could be searching with the intent of scheduling travel or researching the science of flight. In an attempt to address this issue, an advertiser can select keywords and keyword combinations that are more likely to be associated with a particular intent.

Several advertisement payment models also have been developed. In one model, an advertiser pays a fee every time an advertisement is displayed to a user. Under this model, the advertiser will not receive the optimum return on investment through a keyword-based campaign unless the keyword happens to be uniquely associated with the advertisement. Without such unique identity, the advertisement will be displayed to users who have a different search intent, thereby incurring charges to the advertiser for impressions that have a relatively low likelihood of generating business.

In another model, the search engine provider is paid by the advertiser based on the number of times an advertisement is clicked-through (or accessed) by a user. Under this model, the search engine provider will not generate advertising revenues at the optimum rate unless the keyword in a received search string is uniquely associated with the displayed advertisement. Users will be unlikely to click-through based on an advertisement that is irrelevant to their present intent.

### SUMMARY

The present inventors recognized the need to provide an improved system and method for associating an advertisement with input received from a user, such as information comprising a search request, and for selecting one or more advertisements associated with particular input criteria for presentation. Further, the need was recognized to use one or more labels in selecting and presenting advertisements that are relevant to input received from a user. Additionally, the present inventors recognized the need to permit an advertiser to view labels used to characterize web pages and to associate one or more of such labels with an advertisement.

The present inventors also recognized the need to capture a user's interest level at the time input is received and to present one or more advertisements relevant to that interest level. The present inventors further recognized the need to associate an advertisement with input criteria comprising one or more labels or a combination of one or more labels and one or more keywords. Additionally, the need was recognized to permit an advertiser to specify a bid for associating a label with an advertisement, wherein the bid can increase or decrease the amount the advertiser is willing to pay to have the advertisement presented. The present inventors also recognized the need to permit an advertiser to specify one or more labels in response to which an advertisement should not be presented. Accordingly, the techniques and apparatus described here implement algorithms for associating an advertisement with input criteria based on one or more labels, selecting one or more advertisements associated with particular input criteria for presentation, and permitting an advertiser to specify a bid for associating an advertisement with a label.

In general, in one aspect, the techniques can be implemented to include associating a label with an advertisement; receiving input from a user, wherein the received input comprises one or more labels; identifying a match between the label associated with the advertisement and the received input; and presenting the advertisement to the user.

The techniques also can be implemented such that the received input comprises a search request. The techniques further can be implemented such that presenting further comprises including the advertisement in search results generated in response to the search request. Additionally, the techniques can be implemented to include receiving a bid for presenting the advertisement in response to input from a user that includes the associated label.

The techniques also can be implemented to include determining a presentation order of the advertisement based on one or more of the bid, a click-through rate of the advertisement, and a conversion rate of the advertisement. Further, the techniques can be implemented to include associating a negative label with the advertisement. Additionally, the techniques can be implemented to include receiving an additional input from the user, wherein the input comprises one or more labels, identifying a match between the negative label and the received additional input, and determining not to present the advertisement to the user based on the identified match between the negative label and the received additional input.

The techniques also can be implemented such that the received input comprises a search refinement. The techniques further can be implemented such that presenting the advertisement further comprises modifying a presentation order corresponding to a previous keyword match based on the search refinement. Additionally, the techniques can be implemented to include receiving a bid for presenting the advertisement in response to the search refinement, wherein the bid increases or decreases the amount of a related bid. Further, the techniques can be implemented such that associating a label further comprises selecting the label from a set comprising a plurality of predetermined labels.

In general, in another aspect, the techniques can be implemented to include processor electronics configured to perform operations comprising associating a label with an advertisement, receiving input from a user, wherein the received input comprises one or more labels, identifying a match between the label associated with the advertisement and the received input, and presenting the advertisement to the user.

The techniques also can be implemented such that the processor electronics are further configured to present the advertisement to the user in conjunction with additional content. The techniques further can be implemented such that the processor electronics are further configured to receive a bid for presenting the advertisement in response to input from a user that includes the associated label. Additionally, the techniques can be implemented such that the processor electronics are further configured to determine a presentation order of the advertisement based on one or more of the bid, a click-through rate of the advertisement, and a conversion rate of the advertisement.

The techniques also can be implemented such that the processor electronics are further configured to associate a negative label with the advertisement, receive an additional input from the user, wherein the input comprises one or more labels, identify a match between the negative label and the received additional input, and determine not to present the advertisement to the user based on the identified match between the negative label and the received additional input. The techniques further can be implemented such that the processor electronics are further configured to receive input from the user through a graphical user interface.

In general, in another aspect, the techniques can be implemented to include machine-readable instructions being operable to perform operations comprising associating a label with an advertisement, receiving input from a user, wherein the received input comprises one or more labels, identifying a match between the label associated with the advertisement and the received input, and presenting the advertisement to the user.

The techniques also can be implemented such that the received input comprises a search request. Further, the techniques can be implemented such that the machine-readable instructions for presenting are further operable to perform operations comprising including the advertisement in search results generated in response to the search request. Additionally, the techniques can be implemented such that the machine-readable instructions are further operable to perform operations comprising associating a negative label with the advertisement. The techniques further can be implemented such that the machine-readable instructions are further operable to perform operations comprising receiving an additional input from the user, wherein the input comprises one or more labels, identifying a match between the negative label and the received additional input, and determining not to present the advertisement to the user based on the identified match between the negative label and the received additional input.

The techniques also can be implemented such that the received input comprises a search refinement. The techniques further can be implemented such that the machine-readable instructions for presenting are further operable to perform operations comprising modifying a presentation order corresponding to a previous keyword match based on the search refinement. Additionally, the techniques can be implemented such that the machine-readable instructions are further operable to perform operations comprising receiving a bid for presenting the advertisement in response to the search refinement, wherein the bid increases or decreases the amount of a related bid.

In general, in another aspect, the techniques can be implemented to include receiving input from a user, wherein the received input comprises one or more labels, identifying one or more relevant advertisements based on a match between the received input and one or more labels having predetermined associations with a plurality of advertisements, and presenting at least one relevant advertisement.

The techniques also can be implemented to include receiving search criteria prior to receiving input from the user and presenting search results and corresponding labels in response to the received search criteria. The techniques further can be implemented such that the received search criteria comprises at least one keyword. Additionally, the techniques can be implemented such that the corresponding labels are associated with a predetermined context. Further, the techniques can be implemented to include determining a presentation order of each relevant advertisement based on a corresponding bid.

The techniques described in this document can be implemented to realize one or more of the following advantages. For example, the techniques can be implemented to increase the relevance of a presented advertisement to input received from a user. Further, the techniques can be implemented to capture a user's interest level at the time input is received without the need to collect information describing the user or the user's search history. The techniques also can be implemented to generate a higher click-through rate for an advertisement by associating the advertisement with relevant subject matter. Additionally, the techniques can be implemented such that a search engine provider can control the labels with which an advertisement can be associated. Further, the techniques can be implemented to permit an advertiser to target an advertisement to users who express a particular interest. The techniques also can be implemented such that interpretation of a keyword is constrained by a particular context. Further, the techniques can be implemented to obtain efficiency in advertising costs and revenue by increasing the relevance of an advertisement to the input that results in its presentation.

These general and specific techniques can be implemented using an apparatus, a method, a system, or any combination of an apparatus, methods, and systems. The details of one or more implementations are set forth in the accompanying drawings and the description below. Further features, aspects, and advantages will become apparent from the description, the drawings, and the claims.

### BRIEF DESCRIPTION OF THE DRAWINGS

FIG. 1 depicts a flowchart for presenting an advertisement in response to user input comprising a label.

FIG. 2 depicts a flowchart for presenting an advertisement in response to user input comprising labels and keywords.

FIG. 3 depicts an ad group that associates labels with an advertisement.

FIG. 4 is a block diagram of a computing architecture.

FIG. 5 is a user interface for searching using labels.

FIG. 6 depicts search results and advertisements generated in response to a search request including a label.

FIG. 7 depicts a method of presenting an advertisement.

Like reference symbols indicate like elements throughout the specification and drawings.

### DETAILED DESCRIPTION

One or more advertisements can be included in content presented in response to input received from a user, such as a request or a command. For example, one or more advertisements can be included in search results presented to a user in response to a search request. An advertisement can comprise text, one or more images, a hyperlink, audio, video, or any combination thereof. Further, the relevance of an advertisement to the content with which it is presented can be increased through the use of one or more labels.

A label can be used to classify information, such as by identifying a category of information within a broader topic. For example, a label can indicate an intended audience, an intended use, a source, a type of document, or a subject. Further, a set of one or more labels can be defined such that they relate to a particular context. Thus, the meaning of a label can be constrained by the context with which it is associated.

Both advertisements and content can be classified and thus described using labels. One or more labels can be assigned to, or otherwise associated with, the advertisement or item of content being classified. For example, the one or more labels to be assigned to an advertisement can be selected from a predetermined set of labels. Further, a label corresponding to an advertisement or item of content can be specifically identified as a label. Therefore, one or more labels associated with an advertisement or item of content can be accessed and the classification can be determined. The classification can be limited to indicators specifically identified as labels. Additionally, one or more labels can be selected from a predetermined list for use as search criteria. Search results can be generated by identifying content associated with the selected labels. In contrast, a keyword can be any word that appears in or is associated with a document or file, such as a web page.

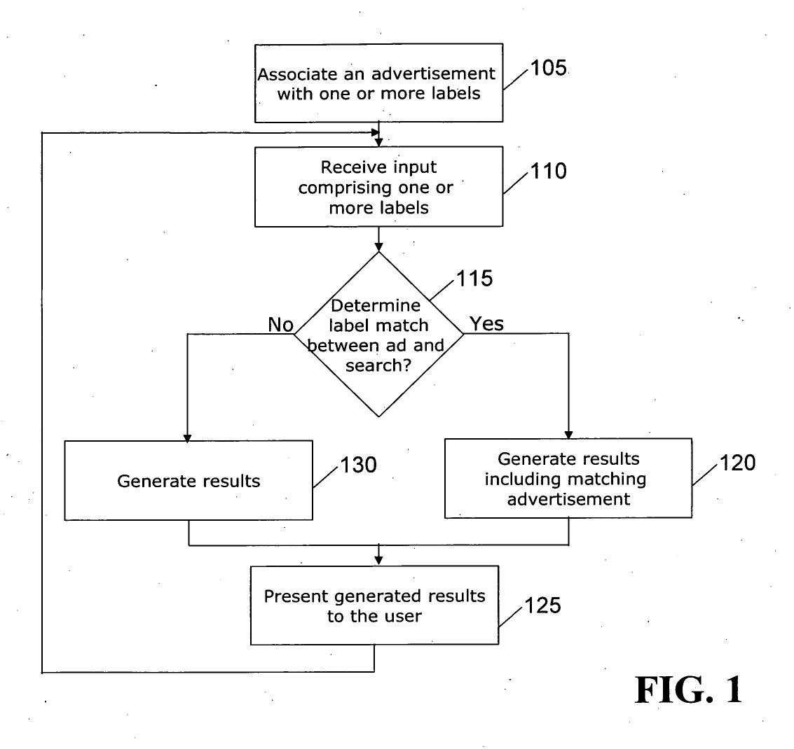

FIG. 1 is a flowchart describing a method of presenting an advertisement, such as for a product or service, based on a label included in an input received from a user. First, the advertisement is associated with one or more labels (105). The one or more labels can be selected from a predetermined set of labels that relate to a particular context (or vertical). Because a context relates to a specific topic, the meanings attributed to the labels comprising the predetermined set can be constrained by their uses within that topic. Additionally, the labels can be selected such that they provide an indication of the user's intent at the time the input is submitted. For example, a user selecting the label “For prospective buyers” indicates that she is considering making a purchase.

The information provider, such as a search engine, can receive from a user input comprising one or more labels, such as search request (110). Input can be submitted using any data entry device, including a keyboard, mouse, microphone, touch screen, touch pad, one or more buttons, or any combination thereof. For example, input can be submitted through a GUI, such as a web browser, hosted on a computer or a web-enabled phone. Further, the information comprising the user input can be entered through any data entry technique, such as user selectable text, a drop-down menu, or a form entry box. In an implementation, a user can be presented with a predetermined list including one or more labels that are available within a particular context for use in developing or refining a search request.

The information provider is configured to compare the one or more labels comprising the input with the one or more labels associated with an advertisement to determine whether a match exists (115). An exact match can be required if the labels associated with the advertisement and the labels comprising the input cannot vary. For example, if the input is entered by selecting from a set of predetermined labels. Alternately, if one or more labels comprising the input are manually entered by a user, a broad match or probably match standard can be applied.

Additionally, the one or more labels comprising an input can be compared with labels associated with a plurality of advertisements. For example, the information provider can be configured to access one or more advertisement databases, which can include information identifying the one or more labels associated with each of a plurality of advertisements. When an input is received, any or all of the advertisements included in an advertisement database can be evaluated with respect to the input to identify whether a match exists.

In an implementation, a negative label can be associated with an advertisement to indicate a circumstance in which the advertisement should not be presented. Further, the information provider can be configured such that a negative label predominates over any other match condition. For example, any label included in a predetermined set of labels that relate to a particular context also can be used as a negative label. The information provider can be configured to compare the one or more labels comprising the input with one or more negative labels associated with an advertisement to determine whether a match exists. If a label comprising the input matches a negative label associated with an advertisement, that advertisement will not be presented to the user.

If a match between the one or more labels comprising the received input and one or more labels associated with an advertisement is identified, results corresponding to the received input are generated such that they include the one or more matching advertisements (120). In an implementation, the matching advertisements can be ordered for presentation based on one or more ranking criteria, including a bid, a relevance factor, a risk factor, or an effectiveness metric. Further, the information provider can be configured to select only a subset of the matching advertisements for presentation. The generated results are then presented to the user (125). The generated results can be presented through any data output device, including a display, a printer, a speaker, or any combination thereof. For example, the results can be presented to a user through a GUI, such as a web browser, hosted on a computer or a web-enabled phone.

If a match between the one or more labels comprising the received input and one or more labels associated with an advertisement is not identified, results corresponding to the input are generated such that an advertisement is not included based on a label in the input (130). For example, if the received input is a search request, a list of web sites or web pages satisfying the search criteria can be generated. Additionally, one or more advertisements can be included in the generated results based on other selection criteria. The generated results are then presented to the user (125).

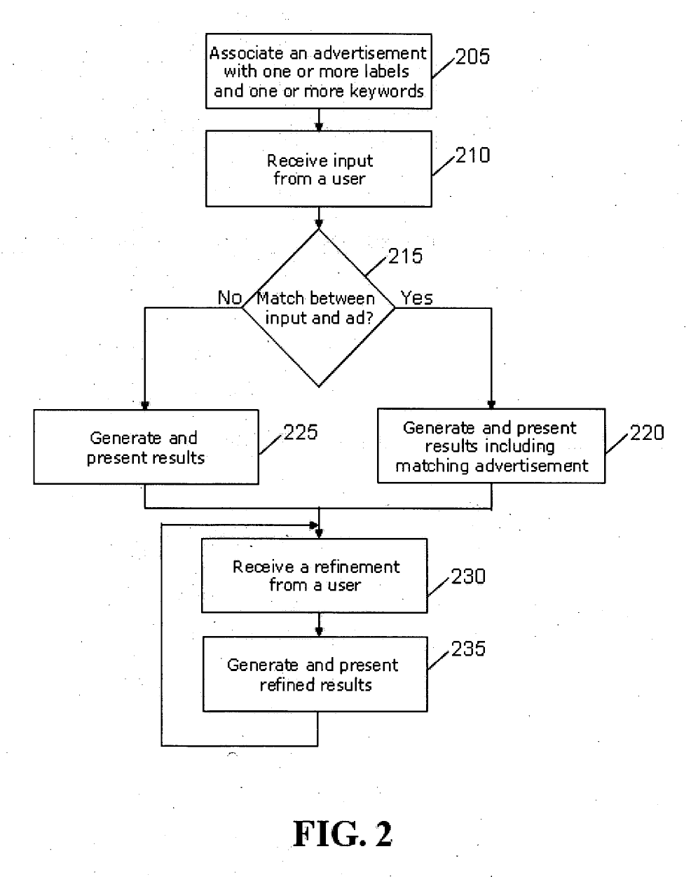

A combination of one or more labels and one or more keywords also can be associated with an advertisement. FIG. 2 is a flowchart describing a method of presenting an advertisement based on user input comprising one or more labels and one or more keywords. First, an advertisement can be associated with a combination of one or more labels and one or more keywords (205). As discussed above, labels can be selected from a predetermined set. Thus, an information provider can control the labels that are used to categorize or classify information, such as content and advertisements. Labels can be added to and removed from a predetermined set as desired. Additionally, a keyword can be any term, including a word, a number, an identifier, or any other such information.

An information provider can receive input from a user, such as a search request (210). The received input can comprise any combination of one or more keywords and one or more labels. For example, a user can input an initial search request comprising a single keyword, such as arthritis. The information provider can be configured to compare the input received from the user with one or more advertisements to determine whether a match exists between the input and any keywords and labels associated with the advertisement (215). For example, one or more advertisements accessible to the information provider can be evaluated to determine which, if any, are associated with the keyword arthritis. A similar evaluation can be performed for any additional keywords and labels included in the received input. As discussed above, a negative label or a negative keyword also can be associated with an advertisement to prevent the advertisement from being presented.

If a match between the input and a label or keyword associated with an advertisement is identified, the matching advertisement can be included in the results generated and presented in response to the input (220). If a match between the input and a label or keyword associated with an advertisement is not identified, results corresponding to the input are generated and presented such that a matching advertisement is not included (225). The content comprising the generated results can consist of any material, including additional advertisements, regardless of whether a matching advertisement is identified.

After the generated results have been presented, additional input representing a refinement can be received from a user (230). A refinement can comprise one or more keywords, one or more labels, or any combination thereof. For example, search results generated and presented in response to the keyword arthritis can be refined using input that specifies a label, such as Drug_uses. A user can specify a refinement to more accurately indicate the type of information that is relevant to the current search.

Upon receiving additional input representing a refinement, the information provider can be configured to generate and present refined results to the user (235). Generating refined results can include eliminating one or more advertisements from the results, adding one or more advertisements to the results, and revising the presentation order of one or more advertisements. Because a refinement provides an additional indication of the user's intent, the relevance of an advertisement to the results can be reevaluated. If an advertisement previously included in the generated results also is associated with one or more of the keywords and/or labels comprising the refinement, it can be determined that the advertisement has greater relevance to the user.

For example, an advertisement directed to an arthritis drug can be more relevant to refined search criteria comprising the keyword arthritis and the label Drug_uses than to the initial search criteria comprising only the keyword arthritis. Because the click-through rate of an advertisement can be influenced by its relevance to the information sought by a user, there can be increased interest in having an advertisement presented in response to refined search criteria, such as the advertisement directed to an arthritis drug. Thus, an advertiser may bid an increased amount to have an advertisement presented in response to the refined search criteria. Similarly, an information provider can choose to elevate the presentation order of a more relevant advertisement to further increase the likelihood that it will generate a click-through.

In an implementation, an advertisement that matches the refined input received from a user can still be required to compete with one or more advertisements that match only the initial input received from a user. For example, an advertisement that matches the search criteria arthritis and Drug_uses can still be required to compete with an advertisement associated only with the search criteria arthritis. Thus, based on the ordering criteria utilized by the information provider, one or more advertisements that do not match the refined input can be presented ahead of an advertisement that matches the refined input.

Additionally, the refined input can indicate that an advertisement is less relevant to a user, such as in the case of a negative label. For example, the advertiser can choose not to display an advertisement directed to an arthritis drug in response to a refinement that specifies a label such as Alternative_medicine. Because the refined input indicates that the advertisement is less relevant to the information sought by the user, it can be determined that the likelihood of the advertisement generating a click-through has decreased.

An information provider that presents advertisements, such as the information provider discussed with respect to FIG. 1 and FIG. 2, can be configured as an auction system. In an auction system, a plurality of advertisers can specify bids to the information provider for presenting an advertisement in response to input received from a user. The information provider can evaluate the bids, along with one or more other factors, in determining which advertisements to present and in which order the advertisements are to be presented.

In another implementation, an information provider can be configured as a different type of system, such as a subscription system, a reservation system, or a contract system. For example, in a subscription system, a user can select one or more labels in order to subscribe to one or more advertisement types. Advertisements corresponding to one or more of the subscribed labels then can be included in content presented to the user. In a reservation system, an advertiser can reserve a portion of a media segment, such as display space on a web page or a temporal segment in a media stream, in which an advertisement can be displayed upon receiving input from a user comprising a label or label/keyword combination associated with the advertisement. Additionally, in a contract system, a third-party can agree to present advertisements associated with a label or a label/keyword combination that are supplied by the information provider in response to specific input received from a user.

An advertisement group (or “ad group”) can be generated to specify one or more labels associated with one or more advertisements. An ad group also can be used to define keywords and additional parameters associated with an advertisement, such as an amount an advertiser is willing to pay in order to have the advertisement displayed in response to a received search request that includes one or more of the associated labels. In another implementation, one or more labels also can be associated with an advertising campaign comprising a plurality of ad groups. For example, a label designated at the advertising campaign level can be associated with every advertisement included within the advertising campaign.

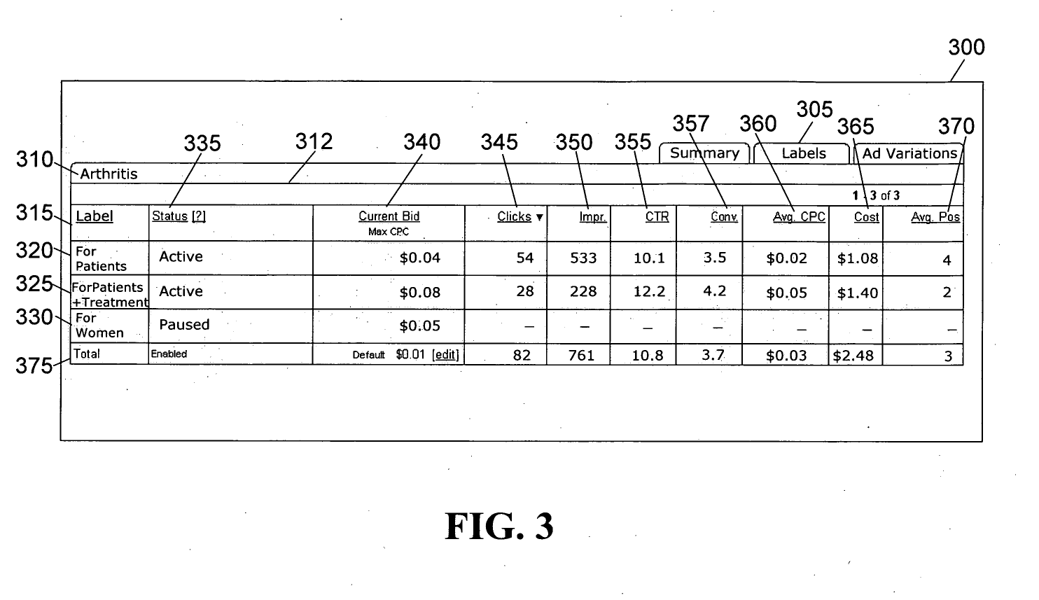

FIG. 3 depicts an ad group summary 300 describing an ad group that comprises one or more advertisements. Each advertisement included in the ad group can be associated with one or more labels. Additionally, within the ad group, the labels associated with an advertisement can be constrained to a single context (or vertical), such as health, travel, autos, or computer and video games.

The ad group summary 300 can be presented using one or more screens, including a labels screen 305. When the labels screen 305 is displayed, each of the labels associated with the ad group can be viewed. The ad group summary 300 also can include a topic identifier 310 that indicates the context in which the labels are used. For example, the topic identifier 310 can specify an illness or medical condition, such as arthritis. In another implementation, the topic identifier 310 can identify one or more keywords that also are associated with the advertisement.

The labels screen 305 of the ad group summary 300 can be configured to present information relating to the associated labels in graphical form, such as a chart 312. A first row 315 of the chart 312 can identify the categories of information being presented. Additional rows, such as the second row 320, third row 325, and fourth row 330, can present information associated with a specific label or combination of labels. Further, the last row 375 of the chart 312 can present an ad group total for one or more categories of information.

For example, information corresponding to the label “For patients” is presented in the second row 320 of the chart 312, information corresponding to the label combination comprising “For patients”+“Treatment” is presented in the third row 325, and information corresponding to the label “For women” is presented in the fourth row 330. Further, an advertiser can specify the status of each label or label combination in an ad group, to indicate which labels should be evaluated in determining whether to select an advertisement for display. For example, the status column 335 of the labels summary 305 indicates that the label “For patients” and the combination “For patients”+“Treatment” are active, while the label “For women” is paused. Thus, an advertisement associated with the ad group will be evaluated for display if a search request containing either the label “For patients” or the label combination “For patients”+“Treatment” is received. Similarly, an advertisement associated with the ad group will not be evaluated for display in response to a search request consisting of the label “For women”. In an implementation, a label or label combination also can be assigned a status other than active or paused. For example, if a label has been removed from use in an ad group, that label can remain visible to the advertiser and be designated as deleted in the status column 335.

The labels screen 305 also can be configured to present a current bid 340 associated with each label in an ad group. The current bid 340 can be used to specify the maximum cost-per-click that an advertiser is willing to pay. For example, the current bid 340 associated with the label “For patients” is $0.04. Thus, if an advertisement in the ad group is displayed in response to a received search request that includes the label “For patients” and the advertisement generates a click-through, the advertiser can be charged an amount up to $0.04.

Bids, including the current bid 340, can be expressed in terms of an absolute value or a relative value. An absolute value specifies a discrete amount, such as a monetary figure. A relative value specifies a change in value of another bid, such as a percent increase or decrease. For example, an absolute value can be associated with a first label or keyword, such as arthritis. Inclusion of an additional label or keyword in the user input, such as the label Drug_uses, can indicate that an advertisement has increased relevance to the user. Therefore, an advertiser can specify an increase to the bid associated with the first label or keyword based on the inclusion of the additional label or keyword. For example, the bid associated with the first label or keyword can be increased by twenty percent. Alternately, if inclusion of the additional keyword or label indicates that the advertisement has decreased relevance to the user, the advertiser can specify a decrease to the bid. Relative value bidding also can be used in place of a negative label. For example, if the inclusion of a particular label or keyword eliminates an advertiser's desire to present an advertisement, the relative value bid associated with that label or keyword can reduce the value of any related bid to zero.

An information provider also can evaluate the relevance of an advertisement to the one or more labels and keywords bid on by an advertiser to determine the probability of the advertisement generating a click-through. If the information provider believes that the relevance of the advertisement to the selected one or more labels and keywords is low, the information provider can demand the advertiser to bid at least an amount determined to offset the risk of displaying the advertisement. In an implementation, the advertiser further can accept the minimum bid requirement and counter with a conditional bid that specifies an amount, such as a lower value, the advertiser is willing to pay if the advertisement actually generates a click-through.

An advertiser also can specify label combinations and label/keyword combinations on which the advertiser is willing to bid. For example, if the label combination “For patients”+“Treatment” indicates a higher degree of relevance between a search request and the associated advertisement than the label “For patients” taken alone, the advertiser can bid an increased maximum cost-per-click, such as $0.08. Because a maximum cost-per-click can be specified for each label or combination in an ad group, an advertiser can customize the maximum amount to be paid per click based on the perceived degree of relevance.

Additionally, the labels screen 305 can be configured to present information relating to the effectiveness of a particular label or label combination. The labels screen 305 can present the number of clicks 345 that have been generated as a result of the association between an advertisement and a label or label combination. Further, the labels screen 305 can present the number of impressions 350 (the number of times an advertisement was shown) attributable to a particular label or label combination. Based on the number of clicks 345 and the number of impressions 350, the click-through rate (CTR) 355 for a label or label combination also can be determined and displayed. For example, the label combination “For patients”+“Treatment” generated 28 clicks based on 228 impressions, for a CTR of 12.2%. The conversion rate 357 further can be displayed to indicate how frequently an accessed advertisement generates a conversion. Alternately, the number of conversions can be displayed.

The labels screen 305 further can be configured to present information relating to the cost of a particular label or label combination. Although the current bid 340 representing a maximum cost per click can be specified, the cost of each click is independently evaluated and can be lower than the maximum cost per click. Thus, the labels screen 305 can present an average cost per click 360 and a total cost 365 associated with each label or label combination. For example, the average cost per click 360 for an advertisement associated with the “For patients” label is $0.02 and the total cost 365 is $1.08.

Further, an average position 370 can be displayed to indicate the average position in which an advertisement associated with a particular label or label combination appears when displayed. The display position of an advertisement can be affected by one or more factors, such as the current bid 340, the CTR 355, and the number of advertisements associated with the same label or label combination. For example, an advertisement in the ad group that is associated with the label “For patients” on average occupies the fourth display position. Depending on the current bids 340 entered by competing advertisers who also have associated an advertisement with the “For patients” label, the average position 370 could be improved by increasing the current bid 340. In another implementation, the average position 370 of an advertisement can increase as the CTR of the ad increases.

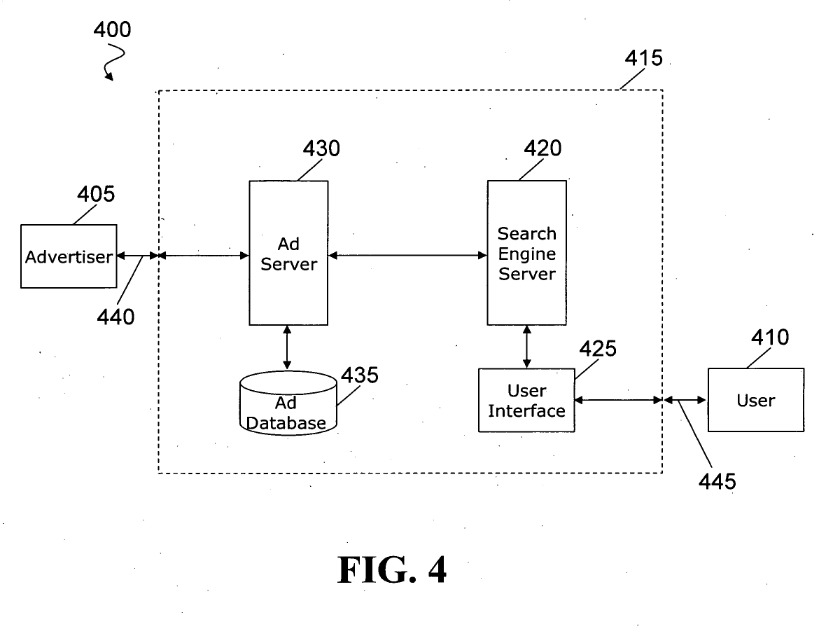

FIG. 4 depicts a computing architecture 400 in which a label-based advertisement selection strategy can be implemented. The computing architecture 400 can include an advertiser client 405 and a user client 410 that comprise computing devices, such as a desktop computer, a laptop computer, a hand-held computer, a web-enabled telephone, a workstation, or any other computing device configurable to serve as a client. The computing architecture 400 also can include a search engine platform 415 that can be configured to include a search engine server 420, a user interface 425, an ad server 430, and an ad database 435.

The advertiser client 405 and the user client 410 further can be configured to transmit data to and receive data from the search engine platform 415 over communication links 440 and 445 respectively. The communication links 440 and 445 can comprise any type of communication channel, including a wired network connection, a wireless network connection, and a dial-up connection. Additionally, the devices included in the search engine platform 415 can be interconnected, such as by a local area network, a bus, a cable interface, or any combination thereof.

In the computing architecture 400, one or more advertiser clients 405 can be configured to interact with the ad server 430 through a special purpose application or a general purpose application, such as a web browser. The advertiser client 405 can specify an advertisement with which one or more labels are to be associated. Further, the ad server 430 can be configured to store the associations between an advertisement and one or more labels in the ad database 435. Additionally, the advertiser client 405 can be configured to interact with the ad server 430 to create and manage an ad group and an ad campaign. In another implementation, the advertiser client 405 can associate one or more labels and one or more keywords with a particular advertisement, and the ad server 430 can store the specified associations in the ad database 435.

A user client 410 can submit a search request to the search engine platform 415 through the user interface 425. The user interface 425 can be a special purpose application or a general purpose application, such as a web browser interface. The search request received by the user interface 425 can be forwarded to the search engine server 420, which can generate corresponding search results to be presented to the requesting user. Further, the search engine server 420 can communicate with the ad server 430 to determine whether one or more advertisements correspond to the received search request. For example, the ad server 430 can compare one or more labels included in the search request to the associations stored in the ad database 435. If the one or more labels associated with an advertisement match the one or more labels included in the received search request, the advertisement can be selected for display. The ad server 430 can communicate any selected advertisements to the search engine server 420 to be included in the generated search results, which are communicated to the user client 410 through the user interface 425.

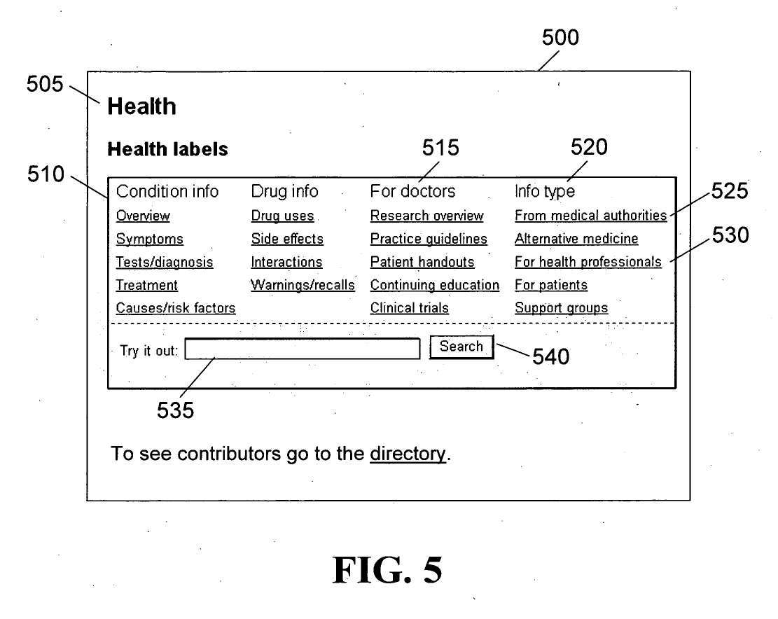

FIG. 5 presents a user interface 500 associated with a search engine, such as a web page, that can be configured to receive a search request from a user. The user interface 500 can include a context identifier 505 to indicate the context (or “vertical”) in which the user is currently searching. The context defines the category or topic to which all of the information accessible in that context relates. For example, all of the information accessible within the Health context identifier 505 relates to the topic of health. A context also can be defined for other topics, such as travel, autos, electronic gaming, stereo & home theater, and photography/videography. Because a search engine provider can control the creation of each context, it also is possible for the search engine provider to ensure that the information accessible within a context relates to the identified topic.

Each context can include a set of search refinements 510 that includes one or more labels available within the context. The set of search refinements 510 can be further organized using facets. A facet can be used to group labels within a given context by adding a subcategory. For example, the facet identifier “For doctors” 515 indicates that the labels appearing in that grouping are intended to provide information that is of relevance to doctors. Similarly, the facet identifier “Info type” 520 groups labels that are associated with specific types of information. For example, within the “Info type” 520 facet, the label “From medical authorities” 525 can be linked to information that is provided by medical authorities and the label “For health professionals” 530 can be linked to information directed to health professionals.

The labels appearing in the user interface 500 can be selected by a user to generate a set of search results corresponding to that label. Further, a user can enter additional search criteria, such as a keyword, into a search field 535 and submit a search request comprising the specified criteria by selecting the search button 540. The keyword can be evaluated in conjunction with one or more selected labels to generate a corresponding set of search results.

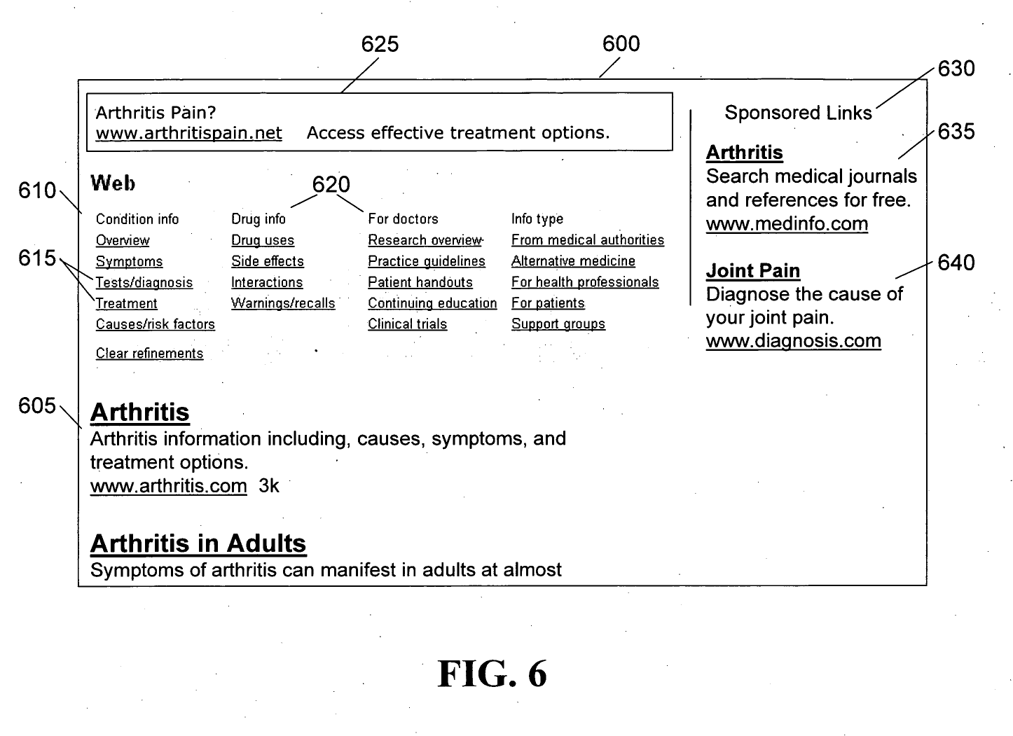

FIG. 6 presents search results 600 generated in response to a search request. The search results 600 can include one or more page identifiers, such as the page identifier 605, that correspond to the specified search criteria. A page identifier can include one or more items of information, including a page title, an excerpt from the corresponding result page, the URL identifying the path to the result page, and the size of the result page. The search results 600 also can include a set of search refinements 610, comprising a plurality of labels, such as the labels 615, and a plurality of facets, such as the facets 620.

Further, the search results 600 can include one or more advertisements. An advertisement can be comprised of text, one or more images, audio, video, one or more hyperlinks, or any combination thereof. The advertisements can be selected for display in the search results 600 based on an identified match between at least one label associated with the advertisement and a label included in the search request. For example, a page identifier ad 625 can be presented in the main body of the search results 600 above one or more unsponsored page identifiers. The page identifier ad 625 also can be graphically distinguished from the unsponsored page identifiers, such as by a different colored background or an outline. In an implementation, an advertisement further can be selected for display in the search results 600 based on an identified match between a label and keyword combination associated with an advertisement and one or more labels and keywords included in the search request.

Further, one or more advertisements also can be displayed as sponsored links 630. The sponsored links 630 can be graphically distinguished from the page identifiers, such as by presenting them in a separate column. Additionally, the sponsored links 630 can be ordered in accordance with one or more factors. For example, in an implementation, a first sponsored link 635 can be displayed above a second sponsored link 640 because the current bid corresponding to the first sponsored link 635 is higher. In another implementation, the first sponsored link 635 can be displayed above the second sponsored link 640 because it has a higher CTR and is therefore perceived to be more relevant to the search results 600. A wide range of factors can be evaluated to determine the display order of the sponsored links.

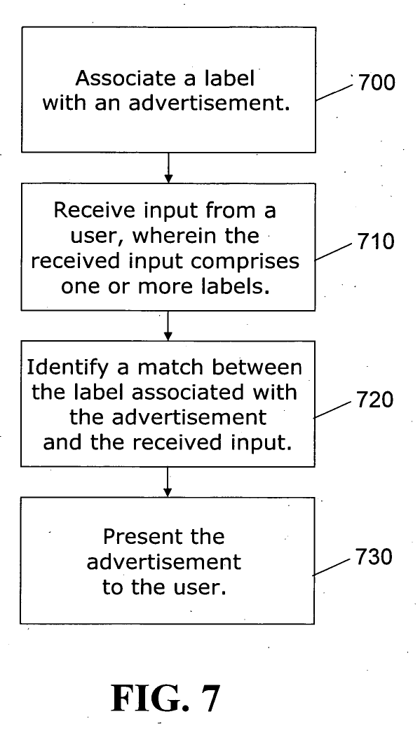

FIG. 7 describes a method of presenting an advertisement. In a first step 700, a label is associated with an advertisement. In a second step 710, input is received from a user, wherein the received input comprises one or more labels. In a third step 720, a match between the label associated with the advertisement and the received input is identified. Once the match has been identified, the fourth step 730 is to present the advertisement to the user.

A number of implementations have been disclosed herein. Nevertheless, it will be understood that various modifications may be made without departing from the spirit and scope of the claims. Accordingly, other implementations are within the scope of the following claims.

What is claimed is:

1. A method of presenting an advertisement, the method comprising:
associating a label with an advertisement;
receiving input from a user, wherein the received input comprises one or more labels;
identifying a match between the label associated with the advertisement and the received input; and
presenting the advertisement to the user.

2. The method of claim 1, wherein the received input comprises a search request.

3. The method of claim 2, wherein presenting further comprises including the advertisement in search results generated in response to the search request.

4. The method of claim 1, further comprising receiving a bid for presenting the advertisement in response to input from a user that includes the associated label.

5. The method of claim 4, further comprising:
determining a presentation order of the advertisement based on one or more of the bid, a click-through rate of the advertisement, and a conversion rate of the advertisement.

6. The method of claim 1, further comprising associating a negative label with the advertisement.

7. The method of claim 6, further comprising:
receiving an additional input from the user, wherein the input comprises one or more labels;
identifying a match between the negative label and the received additional input; and
determining not to present the advertisement to the user based on the identified match between the negative label and the received additional input.

8. The method of claim 1, wherein the received input comprises a search refinement.

9. The method of claim 8, wherein presenting the advertisement further comprises modifying a presentation order corresponding to a previous keyword match based on the search refinement.

10. The method of claim 8, further comprising receiving a bid for presenting the advertisement in response to the search refinement, wherein the bid increases or decreases the amount of a related bid.

11. The method of claim 1, wherein associating a label further comprises selecting the label from a set comprising a plurality of predetermined labels.

12. A system for presenting an advertisement, the system comprising processor electronics configured to perform operations comprising:
associating a label with an advertisement;
receiving input from a user, wherein the received input comprises one or more labels;
identifying a match between the label associated with the advertisement and the received input; and
presenting the advertisement to the user.

13. The system of claim 12, wherein the processor electronics are further configured to present the advertisement to the user in conjunction with additional content.

14. The system of claim 12, wherein the processor electronics are further configured to receive a bid for presenting the advertisement in response to input from a user that includes the associated label.

15. The system of claim 14, wherein the processor electronics are further configured to determine a presentation order of the advertisement based on one or more of the bid, a click-through rate of the advertisement, and a conversion rate of the advertisement.

16. The system of claim 12, wherein the processor electronics are further configured to:
associate a negative label with the advertisement;
receive an additional input from the user, wherein the input comprises one or more labels;
identify a match between the negative label and the received additional input; and
determine not to present the advertisement to the user based on the identified match between the negative label and the received additional input.

17. The system of claim 12, wherein the processor electronics are further configured to receive input from the user through a graphical user interface.

18. An article of manufacture comprising machine-readable instructions for presenting an advertisement, the machine-readable instructions being operable to perform operations comprising:
associating a label with an advertisement;
receiving input from a user, wherein the received input comprises one or more labels;
identifying a match between the label associated with the advertisement and the received input; and
presenting the advertisement to the user.

19. The article of manufacture comprising machine-readable instructions of claim 18, wherein the received input comprises a search request.

20. The article of manufacture comprising machine-readable instructions of claim 19, wherein the machine-readable instructions for presenting are further operable to perform operations comprising including the advertisement in search results generated in response to the search request.

21. The article of manufacture comprising machine-readable instructions of claim 18, wherein the machine-readable instructions are further operable to perform operations comprising associating a negative label with the advertisement.

22. The article of manufacture comprising machine-readable instructions of claim 21, wherein the machine-readable instructions are further operable to perform operations comprising:
receiving an additional input from the user, wherein the input comprises one or more labels;
identifying a match between the negative label and the received additional input; and
determining not to present the advertisement to the user based on the identified match between the negative label and the received additional input.

23. The article of manufacture comprising machine-readable instructions of claim 18, wherein the received input comprises a search refinement.

24. The article of manufacture comprising machine-readable instructions of claim 23, wherein the machine-readable instructions for presenting are further operable to perform operations comprising modifying a presentation order corresponding to a previous keyword match based on the search refinement.

25. The article of manufacture comprising machine-readable instructions of claim 23, wherein the machine-readable instructions are further operable to perform operations comprising receiving a bid for presenting the advertisement in response to the search refinement, wherein the bid increases or decreases the amount of a related bid.

26. A method of presenting an advertisement, the method comprising:
receiving input from a user, wherein the received input comprises one or more labels;
identifying one or more relevant advertisements based on a match between the received input and one or more labels having predetermined associations with a plurality of advertisements; and
presenting at least one relevant advertisement.

27. The method of claim 26, further comprising:
receiving search criteria prior to receiving input from the user; and
presenting search results and corresponding labels in response to the received search criteria.

28. The method of claim 27, wherein the received search criteria comprises at least one keyword.

29. The method of claim 27, wherein the corresponding labels are associated with a predetermined context.

30. The method of claim 26, further comprising:
determining a presentation order of each relevant advertisement based on a corresponding bid.
